(19) United States
(12) Patent Application Publication
(10) Pub. No.: US 2016/0133939 A1
(43) Pub. Date: May 12, 2016

(54) ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Dong-Ho Son, Yongin-si (KR); Ki-Jun Kim, Yongin-si (KR)

(21) Appl. No.: 14/931,795

(22) Filed: Nov. 3, 2015

(30) Foreign Application Priority Data
Nov. 6, 2014 (KR) 10-2014-0153756

(51) Int. Cl. H01M 4/62; H01M 10/0525; H01M 4/70

(52) U.S. Cl. CPC H01M 4/626; H01M 4/70; H01M 10/0525; H01M 2220/30

(57) ABSTRACT

An electrode for a rechargeable lithium battery and a rechargeable lithium battery including the same include a current collector and an electrode active material layer positioned on the current collector. The active material layer includes an electrode active material and a metal fiber, wherein the length of the metal fiber is longer than the thickness of the electrode active material layer.

### CROSS-REFERENCE TO RELATED APPLICATION

This application claims priority to and the benefit of Korean Patent Application No. 10-2014-0153756 filed in the Korean Intellectual Property Office on Nov. 6, 2014, the entire content of which is incorporated herein by reference.

### BACKGROUND

1. Field

One or more embodiments of this disclosure relate to an electrode for a rechargeable lithium battery and a rechargeable lithium battery including the same.

2. Description of the Related Art

In recent times, due to reductions in the size and weight of portable electronic equipment, there has been a need to develop rechargeable lithium batteries for the portable electronic equipment having both high performance and large capacity.

The rechargeable lithium battery may be manufactured by injecting electrolyte into a battery cell that includes a positive electrode and a negative electrode, the positive electrode including a positive active material capable of intercalating/deintercalating lithium and the negative electrode including a negative active material capable of intercalating/deintercalating lithium.

As the performance demands of portable electronic equipment and the like continue to increase, the batteries used for such equipment require higher capacities. Electrodes used in such high-capacity rechargeable lithium batteries may be formed by depositing a thick layer of electrode active material on a current collector.

However, as the electrode becomes thicker, lithium ion and electron movements become difficult, and battery performance deteriorates.

### SUMMARY

One or more embodiments of the present disclosure provide an electrode for a rechargeable lithium battery having excellent electrical conductivity, thus exhibiting good capacity, output characteristics and the like without or substantially without increasing resistance, even when manufactured as a thick film electrode.

One or more embodiments provide a rechargeable lithium battery including the electrode for a rechargeable lithium battery.

One or more embodiments provide an electrode for a rechargeable lithium battery including a current collector and an electrode active material layer positioned on the current collector, the active material layer including an electrode active material and a metal fiber, wherein the length of the metal fiber is longer than the thickness of the electrode active material layer.

The metal fiber may have a length of about 50 μm to about 20 mm.

The electrode active material layer may have a thickness of about 20 μm to about 200 μm.

The length of the metal fiber may be arranged in the electrode active material layer in a direction more parallel (e.g., substantially more parallel) to the current collector than the diameter of the metal fiber in the electrode active material layer. In other words, the length of the metal fiber may be arranged in the active material layer in a direction parallel (e.g., substantially parallel) to the planar surface of the current collector.

The metal fiber may include a metal (e.g., an alloy) selected from stainless steel, aluminum, nickel, titanium, copper and a combination thereof.

The metal fiber may be included in an amount of about 0.1 to about 10 wt % based on total weight of the electrode active material layer.

The metal fiber may have a diameter of about 0.5 μm to about 50 μm.

The current collector may have a foil shape.

One or more embodiments provide a rechargeable lithium battery including a positive electrode; a negative electrode; and electrolyte solution, wherein at least one of the positive electrode and the negative electrode is the electrode containing the metal fiber.

Other embodiments may be included in the following detailed description.

An embodiment of the electrode retains excellent electrical conductivity without or substantially without increasing resistance when manufactured as a high capacity thick film electrode, and may be used in a rechargeable lithium battery having excellent high capacity, output characteristics and the like.

### BRIEF DESCRIPTION OF THE DRAWINGS

The accompanying drawings, together with the specification, illustrate embodiments of the present disclosure, and, together with the description, serve to explain principles of the present disclosure.

FIG. 1 is a cross-sectional view showing the structure of an electrode for a rechargeable lithium battery according to one or more embodiments.

FIG. 2 is a schematic view showing a rechargeable lithium battery according to one or more embodiments.

FIG. 3 is an optical microscope image showing the surface of the positive electrode according to Example 1.

FIGS. 4A and 4B are scanning electron microscope (SEM) images at 750× and 150× magnification, respectively, showing the surface of the positive electrode according to Example 1.

FIG. 5 is a scanning electron microscope (SEM) image showing the cross section of the positive electrode according to Example 1.

FIG. 6 is a graph showing the rate capabilities of rechargeable lithium batteries according to Examples 1 to 3 and Comparative Examples 1 and 2.

### DETAILED DESCRIPTION

Hereinafter, embodiments of the present disclosure are described in more detail. However, these embodiments are examples, and this disclosure is not limited thereto. Also, in the context of the present application, when a first element is referred to as being “on” a second element, it can be directly on the second element or be indirectly on the second element with one or more intervening elements interposed therebetween.

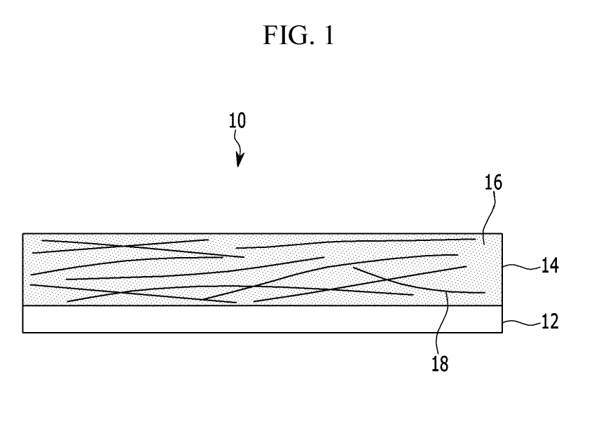

An embodiment of an electrode for a rechargeable lithium battery is illustrated in FIG. 1. FIG. 1 shows an example for the purpose of clarifying the present disclosure, however, the structure of the electrode according to one embodiment is not limited thereto.

FIG. 1 is a cross-sectional view showing the structure of an electrode for a rechargeable lithium battery according to one or more embodiments.

Referring to FIG. 1, the electrode 10 for a rechargeable lithium battery according to one embodiment includes a current collector 12 and an electrode active material layer 14 on the current collector 12, wherein the electrode active material layer 14 includes an electrode active material 16 and a metal fiber 18.

The current collector may play the role of transporting electrons from the electrode to the outside as well as supporting the electrode. The current collector may include a metal of aluminum, copper, nickel, titanium, stainless steel and the like, and may be formed in a foil shape.

The metal fiber has a fiber shape and may have a set (e.g., predetermined) length and diameter. Herein, the length of the metal fiber may be longer than the thickness of the electrode active material layer. When the length of the metal fiber is longer than the thickness of the electrode active material layer, excellent electrical conductivity may be obtained without or substantially without increasing resistance in a high capacity thick film electrode, and thus, a rechargeable lithium battery having excellent output characteristics may be realized.

The thickness of the electrode active material layer and the length of the metal fiber may be measured via optical microscope or scanning electron microscope (SEM) imaging of the electrode.

The metal fiber may have a length of about 50 μm to about 20 mm and in some embodiments, about 500 μm to about 20 mm. In addition, the metal fiber may have a diameter of about 0.5 μm to about 50 μm and in some embodiments, about 1 μm to about 5 μm. When the metal fiber has a length and a diameter within these ranges, excellent electrical conductivity may be obtained.

The electrode active material layer may have a thickness of about 20 μm to about 2 mm and in some embodiments, about 20 μm to about 100 μm. When the electrode active material layer has a thickness within this range, the electrode may exhibit high capacity and high energy density.

As described above, since excellent electrical conductivity may be obtained when the length of the metal fiber is longer than the thickness of the electrode active material layer, the electrode active material layer having a length within the above range and the metal fiber having a thickness within the above range, a rechargeable lithium battery having high capacity and high power characteristics may be realized without or substantially without increasing resistance even in a thick film electrode.

As for the metal fiber, a plurality of metal fibers may be arranged in one direction in the electrode active material layer. For example, the length of the metal fiber may be arranged in a direction more parallel (e.g., substantially more parallel) to the current collector than the diameter of the metal fiber. In other words, the length of the metal fiber may be arranged in the active material layer in a direction parallel (e.g., substantially parallel) to the planar surface of the current collector. When the metal fibers are arranged in the above direction, electrical resistance that is further increased in a length direction is reduced (e.g., electrical resistance along that direction is reduced), and electrical conductivity may thus be further improved in a thick film electrode.

The metal fiber may include a metal (e.g., an alloy) of stainless steel, aluminum, nickel, titanium, copper or a combination thereof. As used herein, the terms “combination thereof” and “combinations thereof” may refer to a chemical combination.

The metal fiber may be included (e.g., included in the electrode active material layer) in an amount of about 0.1 to about 10 wt %, and in some embodiments at about 1 to about 5 wt % based on the total weight of the electrode active material layer. When the metal fiber is included within this range, excellent electrical conductivity may be obtained without or substantially without increasing resistance in a thick film electrode.

The electrode active material may be a positive active material or a negative active material of a rechargeable lithium battery.

In some embodiments, the positive active material may be a compound (lithiated intercalation compound) capable of intercalating and deintercalating lithium, and may be, for example compounds represented by one of the following chemical formulae:

LiₐA_{1-b}B_{b}D₂ (wherein, in the above chemical formula, 0.90≦a≦1.8 and 0≦b≦0.5); LiₐE₁₋bB_{b}O_{2-c}D_{c} (wherein, in the above chemical formula, 0.90≦a≦1.8, 0≦b≦0.5, 0≦c≦0.05); LiE_{2-b}B_{b}O_{4-c}D_{c} (wherein, in the above chemical formula, 0≦b≦0.5, 0≦c≦0.05); LiₐNi_{1-b-c}Co_{b}B_{c}D_{α} (wherein, in the above chemical formula, 0.90≦a≦1.8, 0≦b≦0.5, 0≦c≦0.05, 0<α≦2); LiₐNi_{1-b-c}Co_{b}B_{c}O_{2-α}F_{α} (wherein, in the above chemical formula, 0.90≦a≦1.8, 0≦b≦0.5, 0≦c≦0.05, 0<α<2); LiₐNi_{1-b-c}Co_{b}B_{c}O_{2-α}F₂ (wherein, in the above chemical formula, 0.90≦a≦1.8, 0≦b≦0.5, 0≦c≦0.05, 0<α<2); LiₐNi_{1-b-c}Mn_{b}B_{c}D_{α} (wherein, in the above chemical formula, 0.90≦a≦1.8, 0≦b≦0.5, 0≦c≦0.05, 0<α≦2); LiₐNi_{1-b-c}Mn_{b}B_{c}O_{2-α}F_{α} (wherein, in the above chemical formula, 0.90≦a≦1.8, 0≦b≦0.5, 0≦c≦0.05, 0<α<2); LiₐNi_{1-b-c}Mn_{b}B_{c}O_{2-α}F₂ (wherein, in the above chemical formula, 0.90≦a≦1.8, 0≦b≦0.5, 0≦c≦0.05, 0<α<2); LiₐNi_{b}E_{c}G_{d}O₂ (wherein, in the above chemical formula, 0.90≦a≦1.8, 0≦b≦0.9, 0≦c≦0.5, 0.001≦d≦0.1); LiₐNi_{b}Co_{c}Mn_{d}GₑO₂ (wherein, in the above chemical formula, 0.90≦a≦1.8, 0≦b≦0.9, 0≦c≦0.5, 0≦d≦0.5, 0.001≦e≦0.1); LiₐNiG_{b}O₂ (wherein, in the above chemical formula, 0.90≦a≦1.8, 0.001≦b≦0.1); LiₐCoG_{b}O₂ (wherein, in the above chemical formula, 0.90≦a≦1.8, 0.001≦b≦0.1); LiₐMnG_{b}O₂ (wherein, in the above chemical formula, 0.90≦a≦1.8, 0.001≦b≦0.1); LiₐMn₂G_{b}O₄ (wherein, in the above chemical formula, 0.90≦a≦1.8, 0.001≦b≦0.1); LiQS₂; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is nickel (Ni), cobalt (Co), manganese (Mn), or a combination thereof; B is aluminum (Al), Ni, Co, Mn, chromium (Cr), iron (Fe), magnesium (Mg), strontium (Sr), vanadium (V), a rare earth element, or a combination thereof; D is oxygen (O), fluorine (F), sulfur (S), phosphorus (P), or a combination thereof; E is Co, Mn, or a combination thereof; F is F, S, P, or a combination thereof; G is Al, Cr, Mn, Fe, Mg, lanthanum (La), cerium (Ce), Sr, V, or a combination thereof; Q is titanium (Ti), molybdenum (Mo), Mn, or a combination thereof; I is Cr, V, Fe, scandium (Sc), yttrium (Y), or a combination thereof; and J is V, Cr, Mn, Co, Ni, copper (Cu), or a combination thereof.

The negative active material may be a material that reversibly intercalates/deintercalates lithium ions, a lithium metal, a lithium metal alloy, a material being capable of doping and de-doping lithium, or a transition metal oxide.

The material that reversibly intercalates/deintercalates lithium ions may be any suitable carbon-based material such as a carbon-based negative active material generally used for rechargeable lithium batteries, and examples thereof may include crystalline carbon, amorphous carbon, or a mixture thereof. Examples of the crystalline carbon may include graphites such as amorphous, sheet-shaped, flake, spherical or fiber-shaped natural graphite or artificial graphite, and examples of the amorphous carbon may include soft carbon (low temperature fired carbon), hard carbon, a mesophase pitch carbonized product, fired coke, and the like.

The lithium metal alloy may be an alloy of lithium and a metal selected from sodium (Na), potassium (K), rubidium (Rb), cesium (Cs), francium (Fr), beryllium (Be), Mg, calcium (Ca), Sr, silicon (Si), antimony (Sb), lead (Pb), indium (In), zinc (Zn), barium (Ba), radium (Ra), germanium (Ge), Al, and tin (Sn).

The negative active material capable of doping and de-doping lithium may be Si, SiOₓ (0<x<2), a Si—C composite, a Si—Y alloy (wherein Y is an element selected from an alkali metal, an alkaline-earth metal, Group 13 to 16 elements, a transition metal, a rare earth element or a combination thereof, and not Si), Sn, SnO₂, a Sn—C composite, Sn—Y (wherein Y is an element selected from an alkali metal, an alkaline-earth metal, Group 13 to 16 elements, transition metal, a rare earth element, or a combination thereof, and not Sn), and the like, and at least one of these may be mixed with SiO₂. Y may be selected from Mg, Ca, Sr, Ba, Ra, Sc, Y, Ti, Zr, hafnium (Hf), rutherfordium (Rf), V, niobium (Nb), tantalum (Ta), dubnium (Db), Cr, Mo, W, seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), Cu, silver (Ag), gold (Au), zinc (Zn), cadmium (Cd), boron (B), Al, gallium (Ga), Sn, In, thallium (TI), Ge, P, arsenic (As), Sb, bismuth (Bi), S, selenium (Se), tellurium (Te), polonium (Po), and a combination thereof.

The transition metal oxide may be vanadium oxide, lithium vanadium oxide, and/or the like.

The electrode active material layer may further include a conductive material besides the electrode active material and the metal fiber.

The conductive material may improve the conductivity of an electrode. Examples of the conductive material may include a carbon-based material such as natural graphite, artificial graphite, carbon black, acetylene black, ketjenblack, a carbon fiber and the like; a metal powder of copper, nickel, aluminum, silver, and the like; a conductive polymer such as a polyphenylene derivative and the like; or a combination thereof.

In addition, the electrode active material layer may further include a binder. The binder may play the role of attaching the electrode active material to the metal fiber and the current collector.

Examples of the binder may include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The electrode may be manufactured by coating an electrode active material layer composition on the current collector and then, drying and compressing it.

The electrode active material layer composition may include the electrode active material and the metal fiber and further additionally include the conductive material and the binder.

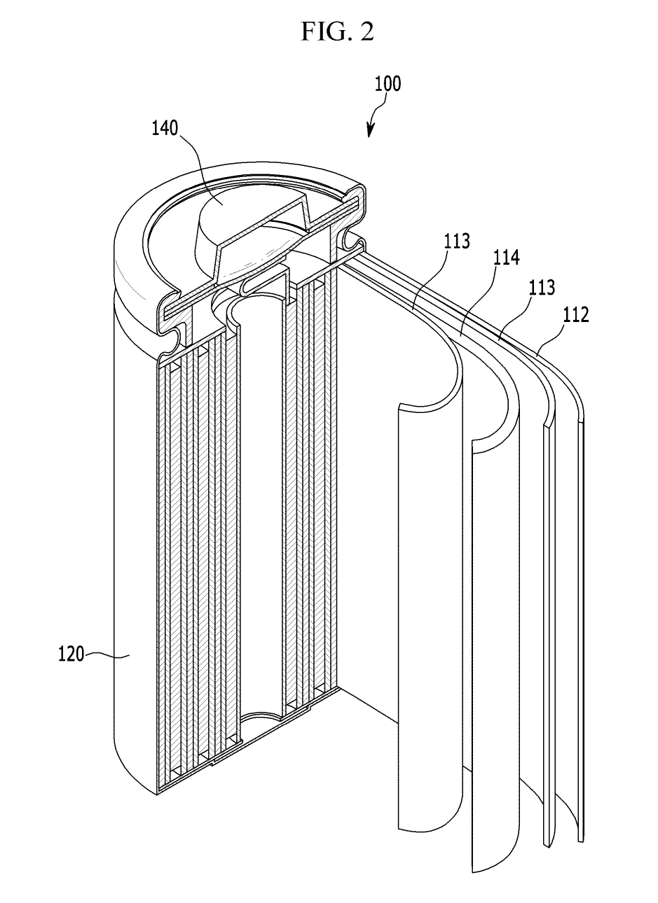

Hereinafter, a rechargeable lithium battery including the electrode is illustrated referring to FIG. 2.

FIG. 2 is a schematic view of a rechargeable lithium battery according to one or more embodiments.

Referring to FIG. 2, a rechargeable lithium battery 100 according to one embodiment includes an electrode assembly including a positive electrode 114, a negative electrode 112 facing the positive electrode 114, a separator 113 interposed between the negative electrode 112 and the positive electrode 114, an electrolyte impregnating the positive electrode 114, the negative electrode 112, and the separator 113, a battery case 120 housing the electrode assembly, and a sealing member 140 sealing the battery case 120.

At least one selected from the positive electrode and the negative electrode may be the electrode containing the metal fiber.

The electrolyte may include a non-aqueous organic solvent and a lithium salt.

The non-aqueous organic solvent may serve as a medium for transmitting ions taking part in the electrochemical reaction of a battery. The non-aqueous organic solvent may be selected from a carbonate-based, ester-based, ether-based, ketone-based, alcohol-based, and aprotic solvent.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like.

An organic solvent having a high dielectric constant and a low viscosity may be obtained when linear carbonate compounds and cyclic carbonate compounds are mixed. The cyclic carbonate and the linear carbonate may be mixed together in (or to) a volume ratio of about 1:1 to about 1:9.

Examples of the ester-based solvent may include methylacetate, ethylacetate, n-propylacetate, dimethylacetate, methylpropionate, ethylpropionate, γ-butyrolactone, decanolide, valerolactone, mevalonolactone, caprolactone, and/or the like. Examples of the ether-based solvent may include dibutylether, tetraglyme, diglyme, dimethoxyethane, 2-methyltetrahydrofuran, tetrahydrofuran, and/or the like, and examples of the ketone-based solvent may include cyclohexanone and/or the like. Examples of the alcohol-based solvent may include ethanol, isopropyl alcohol, and/or the like.

The non-aqueous organic solvents may be used singularly or in a mixture, and when the organic solvents are used in a mixture, the mixture ratio may be controlled in order to attain desirable or suitable battery performance.

The lithium salt may be dissolved in the organic solvent to supply lithium ions in a battery and improve lithium ion transport between the positive and negative electrodes therein.

Examples of the lithium salt may include LiPF₆, LiBF₄, LiSbF₆, LiAsF₆, LiN(SO₃C₂F₅)₂, LiC₄F₉SO₃, LiClO₄, LiAlO₂, LiAICI₄, LiN(CₓF₂ₓ₊₁SO₂)(C_{y}F_{2y+1}SO₂), LiCl, LiI, LiB(C₂O₄)₂ (lithium bis(oxalato) borate, LiBOB), and a combination thereof, wherein x and y are natural numbers.

The lithium salt may be used in a concentration of about 0.1 M to about 2.0 M. When the lithium salt is included within the above concentration range, the electrolyte may support excellent performance and lithium ion mobility due to optimal or suitable electrolyte conductivity and viscosity.

The separator 113 may include any materials suitable for use in a lithium battery, as long as it separates the negative electrode 112 from the positive electrode 114 and provides a transporting passage for lithium ions. In other words, the separator may have a low ion transport resistance and excellent electrolyte impregnation characteristics. The separator material may be selected from glass fiber, polyester, polyethylene, polypropylene, polytetrafluoroethylene (PTFE), and a combination thereof. It may have a form of a non-woven fabric or a woven fabric. Examples of polyolefin-based polymer separators suitable for use in a lithium ion battery include polyethylene, polypropylene and the like. A coated separator including a ceramic component or a polymer material may be used to ensure heat resistance or mechanical strength. The separator may have a mono-layered or multi-layered structure.

Hereinafter, some embodiments are described in more detail with reference to examples. However, the present disclosure is not limited to the examples.

Furthermore, what is not described in this disclosure may be sufficiently understood by those of ordinary skill in the art and will not be illustrated here.

### EXAMPLE 1

LiCoO₂, polyvinylidene fluoride (PVdF), denka black and a stainless steel metal fiber having a length of 500 μm and a diameter of 5 μm were mixed to a weight ratio of 91:2:2:5, and the mixture was dispersed into N-methyl-2-pyrrolidone, preparing a positive active material layer composition. The positive active material layer composition was coated on a 15 μm-thick aluminum foil, then dried and compressed, manufacturing a 60 μm-thick positive electrode.

The positive electrode and lithium metal as a counter electrode were inserted into a battery case, and an electrolyte solution was injected into the case, thereby manufacturing a rechargeable lithium battery cell.

The above electrolyte solution was prepared by mixing ethylene carbonate (EC), propylene carbonate (PC) and dimethyl carbonate (DMC) to a volume ratio of 25:5:70 and dissolving 1.15 M LiPF₆ in the mixed solution.

### EXAMPLE 2

A rechargeable lithium battery cell was manufactured according to the same method as Example 1 except for using a metal fiber having a length of 200 μm and a diameter of 5 μm instead of the metal fiber of Example 1.

### EXAMPLE 3

A rechargeable lithium battery cell was manufactured according to the same method as Example 1 except for mixing LiCoO₂, polyvinylidene fluoride (PVdF), denka black and the stainless steel metal fiber having a length of 500 μm and a diameter of 5 μm to a weight ratio of 93:2:2:3.

### COMPARATIVE EXAMPLE 1

A rechargeable lithium battery cell was manufactured according to the same method as Example 1 except for manufacturing a positive electrode by mixing LiCoO₂, polyvinylidene fluoride (PVdF) and denka black to a weight ratio of 96:2:2.

### COMPARATIVE EXAMPLE 2

A rechargeable lithium battery cell was manufactured according to the same method as Example 1 except for using a metal fiber having a length of 50 μm and a diameter of 5 μm instead of the metal fiber of Example 1.

### Evaluation 1: Visual Analysis of the Electrode Surface and Cross-Section

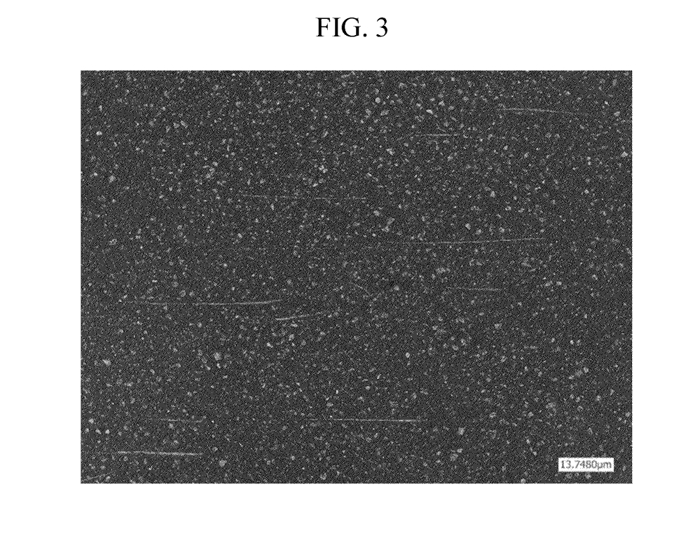

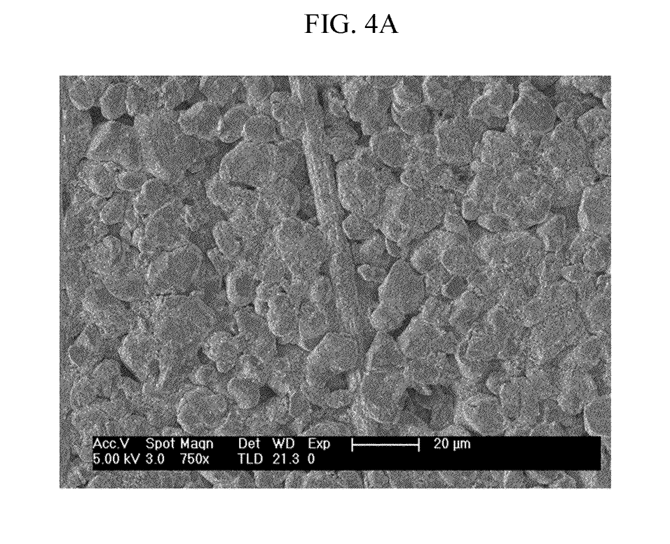

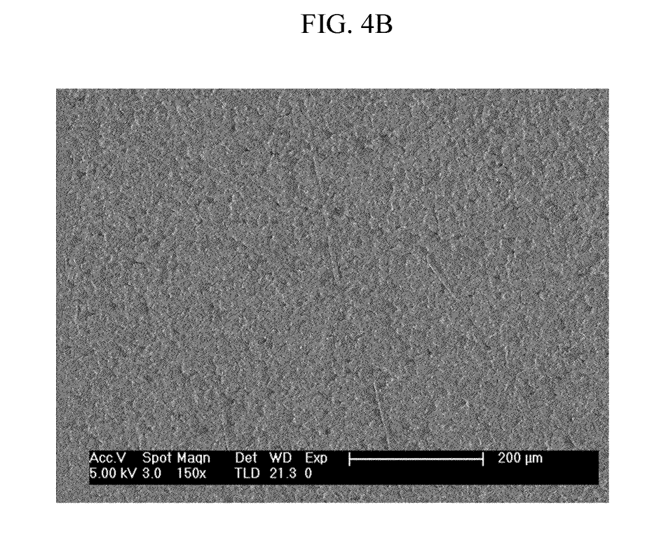

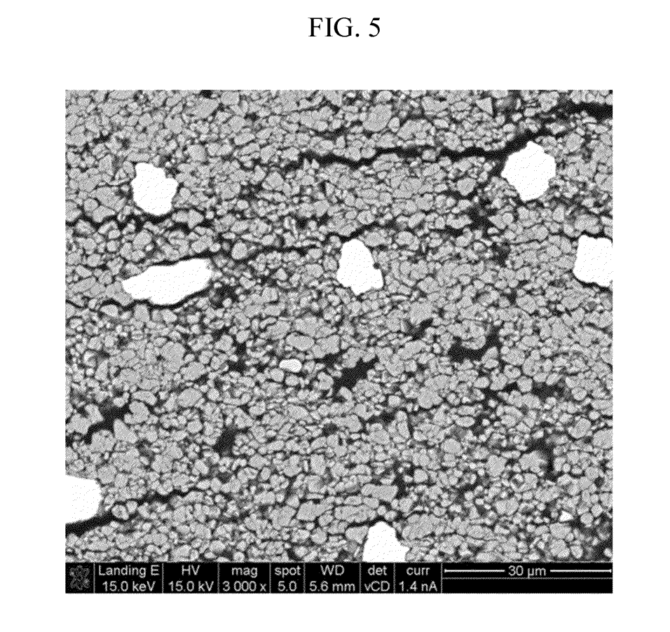

FIG. 3 is an optical microscope image showing the surface of the positive electrode according to Example 1. FIGS. 4A and 4B are scanning electron microscope (SEM) images of the surface of the positive electrode at 750× and 150× magnification, respectively, according to Example 1. FIG. 5 is a scanning electron microscope (SEM) image showing a cross-section of the positive electrode from Example 1.

Referring to FIGS. 3 to 5, in Example 1, the 45 μm-thick positive active material layer was thinner than the length of the metal fiber, and herein, the length of the metal fiber was arranged in a direction substantially more parallel to the current collector than the diameter of the metal fiber. In other words, the length of the metal fiber was arranged in the active material layer in a direction parallel (e.g., substantially parallel) to the planar surface of the current collector.

### Evaluation 2: Output Characteristics of Rechargeable Lithium Battery Cell

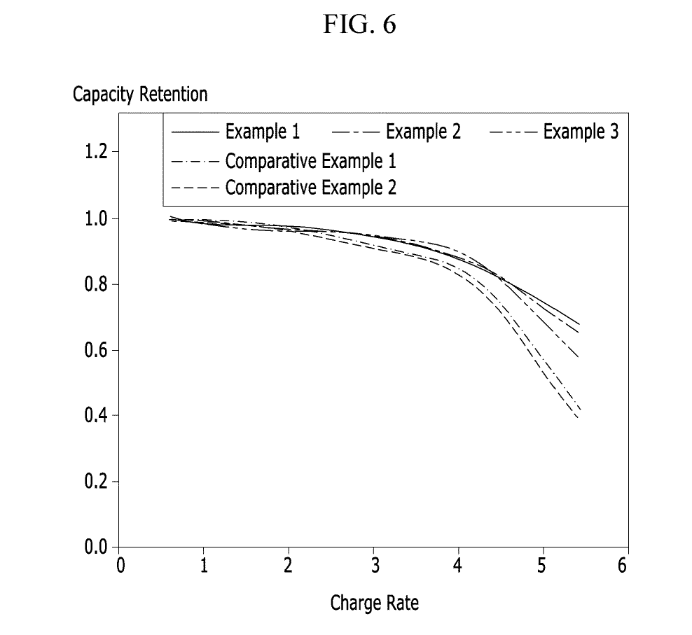

The rechargeable lithium battery cells according to Examples 1 to 3 and Comparative Examples 1 and 2 were charged and discharged according to the following method, and the results are provided in FIG. 6.

The rechargeable lithium battery cells were respectively charged at 4.35 V in a constant current (CC) mode under each current condition of 0.5 C, 1 C, 2 C, 3 C and 5 C, then discharged at 3 V in a CC mode under a current condition of 0.5 C.

FIG. 6 is a graph showing the rate capabilities of the rechargeable lithium battery cells from Examples 1 to 3 and Comparative Examples 1 and 2.

Referring to FIG. 6, the embodiments illustrated in Examples 1 to 3 showed excellent rate capabilities compared with Comparative Examples 1 and 2.

### Evaluation 3: Binding Force of Electrode

Binding forces of the electrodes from Examples 1 to 3 and Comparative Examples 1 and 2 were measured using a binding force measuring instrument, and the results are provided in the following Table 1.

The binding force was measured by respectively cutting the electrodes of Examples 1 to 3 and Comparative Examples 1 and 2 to a size of 2.5 cm², attaching them on glass coated with an adhesive, and then measuring the force in the length direction when the electrodes were peeled off from the glass.

TABLE 1

| | Binding force of electrode (gf/mm) |
|---|---|
| Example 1 | 3.2 |
| Example 2 | 3.0 |
| Example 3 | 2.9 |
| Comparative Example 1 | 2.1 |
| Comparative Example 2 | 1.9 |

Referring to Table 1, the embodiments illustrated by the electrodes of

Examples 1 to 3 showed higher binding forces than the electrode of Comparative Example 1.

### Evaluation 4: Resistance Analysis of Electrode

The electrical conductivity of the electrodes from Examples 1 to 3 and Comparative Examples 1 and 2 was measured using a conductivity measurement instrument, and the results are provided in the following Table 2.

TABLE 2

| | Electrical conductivity of electrode (S/m) |
|---|---|
| Example 1 | 1.222 |
| Example 2 | 1.052 |
| Example 3 | 0.909 |
| Comparative Example 1 | 0.0272 |
| Comparative Example 2 | 0.0288 |

Referring to Table 2, the embodiments illustrated by the electrodes of Examples 1 to 3 showed higher electrical conductivities than the electrode of Comparative Example 1.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims, and equivalents thereof.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, acts, operations, elements, and/or components, but do not preclude the presence or addition of one or more other features, integers, acts, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

### DESCRIPTION OF SOME OF THE SYMBOLS

10: electrode
12: current collector
14: electrode active material layer
16: electrode active material
18: metal fiber
100: rechargeable lithium battery
112: negative electrode
113: separator
114: positive electrode
120: battery case
140: sealing member

What is claimed is:

1. An electrode for a rechargeable lithium battery, comprising:
a current collector; and
an electrode active material layer on the current collector, the electrode active material layer comprising an electrode active material and a metal fiber,
wherein the length of the metal fiber is longer than the thickness of the electrode active material layer.

2. The electrode for a rechargeable lithium battery of claim 1, wherein the metal fiber has a length of about 50 μm to about 20 mm.

3. The electrode for a rechargeable lithium battery of claim 1, wherein the electrode active material layer has a thickness of about 20 μm to about 2 mm.

4. The electrode for a rechargeable lithium battery of claim 1, wherein the length of the metal fiber is arranged in the electrode active material layer in a direction substantially parallel to the planar surface of the current collector.

5. The electrode for a rechargeable lithium battery of claim 1, wherein the metal fiber comprises a metal selected from stainless steel, aluminum, nickel, titanium, copper and a combination thereof.

6. The electrode for a rechargeable lithium battery of claim 1, wherein the metal fiber is included in an amount of about 0.1 to about 10 wt % based on the total weight of the electrode active material layer.

7. The electrode for a rechargeable lithium battery of claim 1, wherein the metal fiber has a diameter of about 0.5 μm to about 50 μm.

8. The electrode for a rechargeable lithium battery of claim 1, wherein the current collector has a foil shape.

9. A rechargeable lithium battery comprising:
a positive electrode;
a negative electrode; and
an electrolyte,
wherein at least one of the positive electrode and the negative electrode is the electrode of claim 1.
